(19) United States
(12) Patent Application Publication
(10) Pub. No.: US 2007/0237234 A1
(43) Pub. Date: Oct. 11, 2007

(54) MOTION VALIDATION IN A VIRTUAL FRAME MOTION ESTIMATOR

(75) Inventor: Fredrik Lidberg, Stockholm (SE)

Correspondence Address: CONNOLLY BOVE LODGE & HUTZ LLP, 1875 EYE STREET, N.W., SUITE 1100, WASHINGTON, DC, 20036, US

(73) Assignee: DIGITAL VISION AB, Solna (SE)

(21) Appl. No.: 11/733,565

(22) Filed: Apr. 10, 2007

Related U.S. Application Data
(60) Provisional application No. 60/744,628, filed on Apr. 11, 2006.

(51) Int. Cl. H04N 11/02; H04B 1/66

(52) U.S. Cl. 375/240.16; 375/240.27

(57) ABSTRACT

A method for motion validation in a virtual frame motion estimator includes selecting motion vectors for a virtual frame C, located at a temporal position between a previous frame P and a subsequent frame N, and computation of an extended error function based on the error for a vector V passing from frame P, through a reference block in the virtual frame C, to frame N, and using additional validation measures computed from vectors −V and +V starting from co-located blocks in P and N respectively, thereby reducing the risk for selecting erroneous vectors for said reference blocks in the virtual frame C.

### CROSS REFERENCE TO RELATED APPLICATIONS

This application is a Non-provisional Application claiming benefit under 35 USC § 119 (e) to Provisional Application 60/744,628 filed on Apr. 11, 2006, the entire contents of which are incorporated herein by reference.

### BACKGROUND

This disclosure concerns a method for motion validation in a motion estimator used for creating motion compensated interpolated virtual frames of digital images.

In certain applications, such as frame rate conversion, it is necessary to find motion vectors which are temporally offset from the source frames. New frames with temporal locations in-between the source frames are generated through interpolation and motion vectors are needed that define the motion at the temporal location of these new frames. One alternative for getting temporally offset motion vectors is to use a standard motion estimator, such as described in U.S. Pat. No. 5,557,341, to produce motion vectors that describe the motion between the source frames. These motion vectors can then be post-processed to produce motion vectors that are temporally offset to be aligned with the new frame to be interpolated. This post-processing is however complex and costly in terms of resources. To achieve high-quality results requires the use of two motion estimators, one operating from the next frame to the previous, backwards in time, and one operating from the previous frame to the next, forward in time.

An alternative approach is to use a virtual frame motion estimator, such as described in U.S. Pat. No. 4,771,331. In a virtual frame motion estimator, define C to be the virtual frame temporally located somewhere between the neighbouring frames P (previous relative to C) and N (next relative to C). To find the motion vector for a reference block in C, a search pattern with simultaneously moving matching points in P and N are used in such a manner that a single intersection point is created for the current block at frame C's position in time for every candidate vector, see FIG. 1 and FIG. 2. The vectors generated in this manner can later be used for motion compensation of frames P and N to generate the frame C. The advantage of this method is that by using one motion estimator, motion vectors at the desired temporal location of C are generated without any post-processing, significantly reducing the computational complexity.

To understand how a single vector is used to motion compensate from both P and N, let's state that the direction of vectors is from frame N to frame P and let's denote d as the fractional offset (range [0.0, 1.0]) of frame C from frame P. Then, for a vector V, to reference frames P and N, a position offset of d*V is used for frame P and a position offset −(1.0−d)*V for frame N, see FIG. 3.

In the virtual frame motion estimator, a problem is identified which is addressed with the described invention. The problem is that through a certain point in the virtual frame several possible motions can be viable. Evaluation of vector candidates using only standard motion estimation criteria, such as described below, can lead to an erroneous choice being made, causing drastic artefacts when constructing the virtual frame C. One example when this becomes particularly evident is when large objects move relatively fast behind stationary small/thin objects. The motion estimator may then select the motion from the large object instead of the zero vector for the position of the small stationary object in the virtual frame, see FIG. 4 for an example. The problems can be aggravated if true motion analysis (e.g. vector field and image analysis) is performed, which often prioritize large objects.

Block matching is a common procedure, known to those skilled in the arts, to find the best motion vector for a reference block by finding the candidate motion vector that minimizes some error function f. In the general case f is a sum of the absolute differences per pixel raised to a power x, where the mean square error (x=2) and sum of absolute differences are two common examples (x=1).

Selected vector=min[f(V)]_{Vε{Candidate vectors}}, where f(V) is the error value for vector V passing through the current reference block in the virtual frame C.

The set of candidates could be chosen as all vectors in a search window or a sub-set of these, possibly complemented by other candidates, such as the zero vector and other vectors determined from neighbourhood or global analysis. In neighbourhood analysis the best vectors from neighbouring blocks are used. Global analysis is used to find global motion, such as camera pans.

Since the reference block in the virtual frame C is actually unknown, it should be clear that a minimization of f(V), which is based on reference blocks in P and N, does not always lead to an unambiguous correct solution. When two or more objects move through the same intersection point in the virtual frame C, those objects (or parts thereof) which should be hidden in the virtual frame C, can still be completely visible in frames P and N. In other words, for these different objects (or parts thereof) we will have f(V) values which are very similar in magnitude and which do not convey anything about the behavior in the unknown virtual frame C.

### BRIEF SUMMARY

In one embodiment, a method for motion validation in a virtual frame motion estimator comprises selecting motion vectors for a virtual frame C, located at a temporal position between a previous frame P and a subsequent frame N. An extended error function is computed based on the error for a vector V passing from frame P, through a reference block in the virtual frame C, to frame N, and using additional validation measures computed from vectors −V′ and V″ starting from co-located blocks in P and N respectively, where −V′ and V″ are found by individually searching a small local area around the vector −V and +V respectively. The vector which minimizes the error function is selected, and further additional validation measures are used and computed using vector analysis from previously computed virtual frames and intermediate level that results in a hierarchical motion estimator in order to create an error term related to previous occurrences of a specific candidate vector, thereby reducing the risk for selecting erroneous vectors for said reference blocks in the virtual frame C.

### BRIEF DESCRIPTION OF THE DRAWINGS

FIG. 1 provides a description of a virtual frame motion estimator. Notice how a search window with corners A-D in P is mapped to a reversed search window in N, giving a single intersection point at the reference block in the sought virtual frame C.

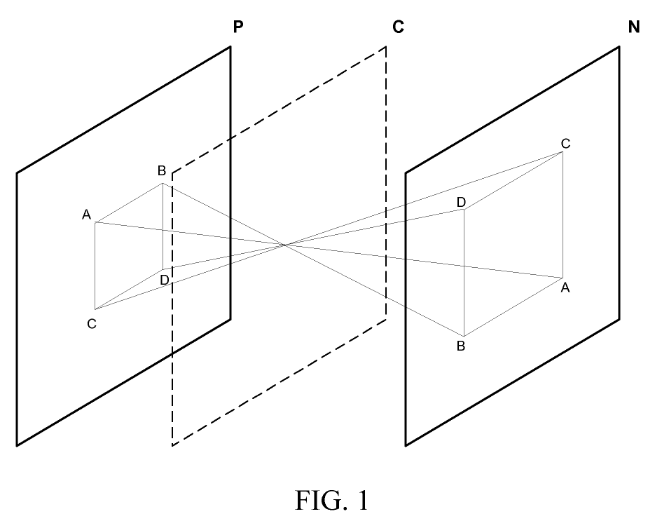

FIG. 2 provides a simplified description of a virtual frame motion estimator in one dimension. Notice how a search range A-B in P is mapped to a reversed search range in N with the intersection point at the reference block in the virtual frame C.

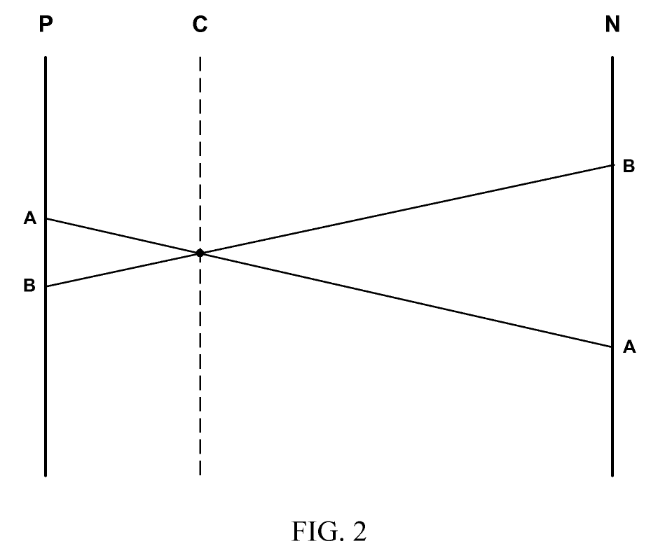

FIG. 3 shows how a single vector from N to P can be scaled and used to access motion compensated data from both the P and N frames to interpolate a frame at temporal position C.

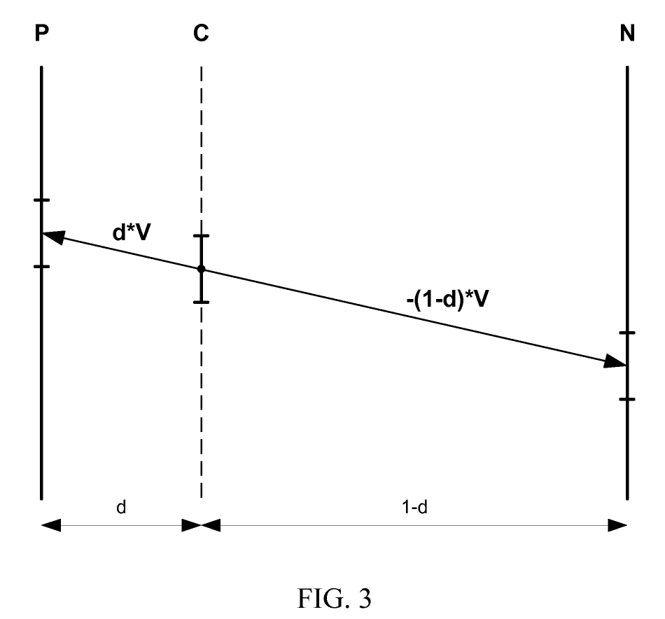

FIG. 4 provides an example showing a large object moving behind a small stationary object. The best vector passing through the reference block in C is found when the block n₁ in N is matched to block p₁ in P, corresponding to the motion of the large object. Observe that this vector does not involve the stationary object at all.

FIG. 5 shows the two additional vectors tested for each vector passing through the reference block in C.

FIG. 6 shows the problem when the flat background is seen in both P and N giving the zero vector the same error value as the vector corresponding to the real motion.

### DETAILED DESCRIPTION

This disclosure describes a method where new additional validation measures are used in the matching criteria of the virtual frame motion estimator.

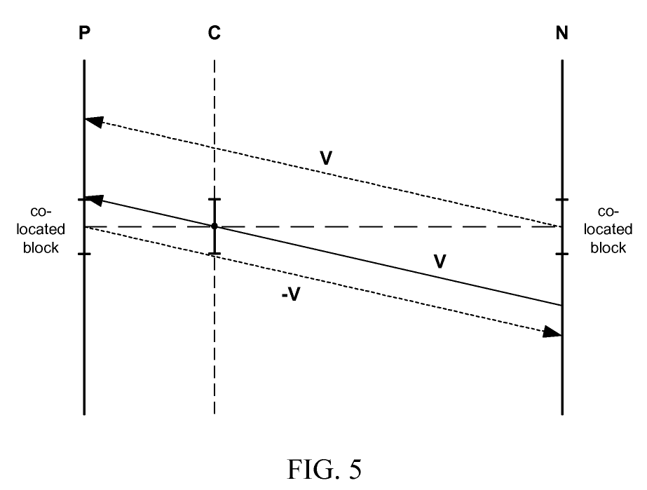

In addition to the vector V passing through the reference block in C, the same vector but starting from co-located blocks in P and N are tested as well. With co-located blocks are meant blocks in P and N located at the same position as the reference block in the C frame. The error functions are computed for the co-located block in P to position offset −V in N as well as for the co-located block in N to position offset V in P, see FIG. 5. Analysing these results in combination with the original error function, we can, to a large degree, avoid selecting erroneous vectors for the reference blocks in the virtual frame C.

The additional motion validation will determine if the co-located blocks (one of them or both) will have similar motion, i.e. are part of the same “motion object”, or not. If one or both of the co-located blocks have similar motion to a good candidate vector for the reference block in C, then that vector is most likely correct. In other words, it should be realized that in such a case it is unlikely that the “motion object” would be hidden at that location in the unknown virtual frame C.

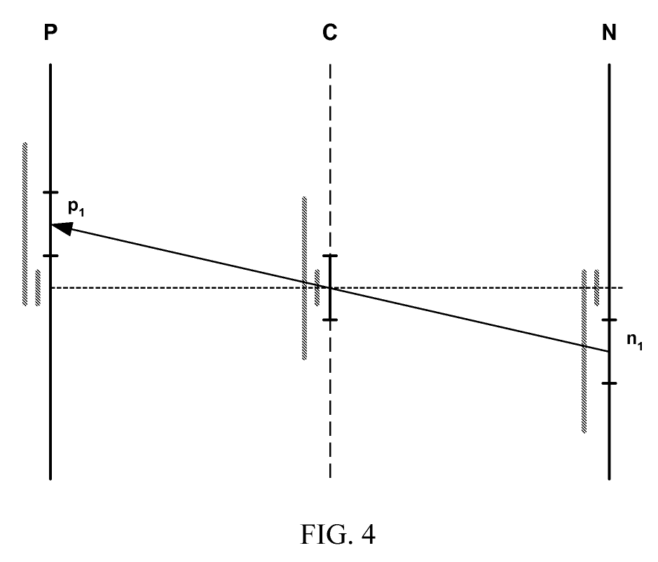

As an example, consider the case with a large object moving relatively fast behind a small stationary object, as pictured in one-dimension in FIG. 4. By minimizing f(V) over a given set of candidates, we find that the best vector relates to the large moving object, which for different reasons is just marginally better than the zero vector. But clearly, by testing the co-location blocks for the corresponding vector we find that this is not a good choice (i.e. results in large errors for both the co-location blocks). For the zero vector candidate, where in this case the co-location test are actually the same as the original test, we find that they are good (i.e. small error) and therefore we would choose the zero vector as the final vector.

The additional validations described above can be combined into an extended test done for each candidate vector passing through the virtual block in C.

Selected vector=min[a*f(V)+b*g(f(V_{PN}), f(V_{NP}))]_{Vε{Candidate vectors}}

where

f(V_{PN}) is the error value for the co-located block in P using the motion vector −V referencing N.

f(V_{NP}) is the error value for the co-located block in N using the motion vector V referencing P.

g(f(V_{PN}), f(V_{NP})) is a function that combines the results of the two error values f(V_{PN}) and f(V_{NP}) for the co-located blocks. A typical example of g is the min function since in most cases it is enough to require one of the two co-located blocks to have a motion similar to the reference block in C.

a and b are weighting factors for the different terms. These are constants selected to provide an optimal balance between the two terms.

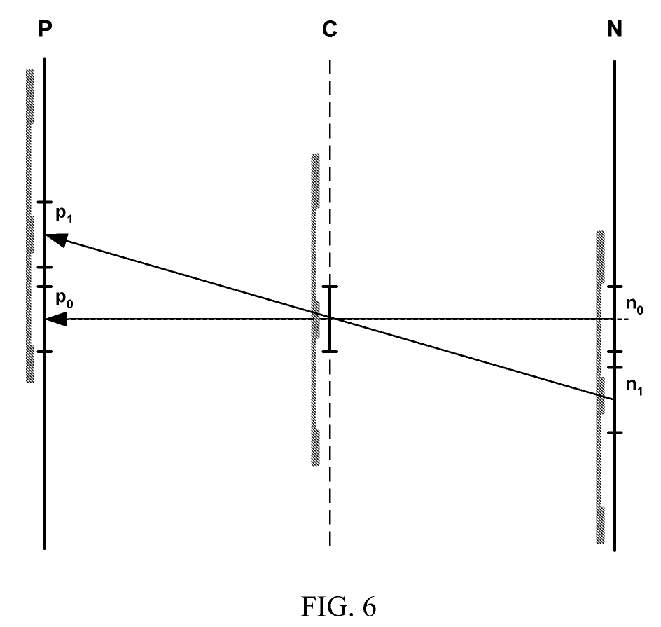

The method described above can be extended to further improve the performance for the identified problem of selecting between several equally viable motion solutions. One extension is to add vector analysis using previously computed virtual frames and intermediate level results in for example a hierarchical motion estimator. Using trajectorial and local analysis, one can construct an error function related to previous occurrences of a specific candidate vector. In other words, if a candidate vector occurs dominantly in the local neighbourhood this error function will output a small value and otherwise a large value. Hence, for those cases that f(V), f(V_{PN}) and f(V_{NP}) are not able to clearly distinguish the correct motion between several candidate vectors, we include a term which relates to how well a vector fits with a “previous” vector field. Using this term we will prioritize large objects (or large collections of smaller objects). This extended method can for example be useful in a situation such as text moving on a flat (stationary or moving) background. The problem is that, at those points where the flat background is visible in both P and N, the zero vector will have just as good an error value as the vector describing the text motion, based on f(V), f(V_{PN}) and f(V_{NP}), see FIG. 6. The selection criteria can then be extended as follows:

Selected vector=min[a*f(V)+b*g(f(V_{PN}), f(V_{NP}))+c*h(V)]_{Vε{Candidate vectors}}

where

h(V) is the error function for the additional tests.

c is the weighting factor for the additional tests. a, b, and c are constants selected to provide an optimal balance between the three terms.

A further extension would be to more thoroughly investigate the motion for the co-located blocks. It should be realized that there is always going to be some uncontrollable amount of error introduced by imposing the “same” vector on the co-located blocks as found for the virtual frame C. This error amount will also be related to image content. For example, a co-location test involving a slightly offset high contrast edge will generate a higher error than an offset flat area. In order to reduce such “random” errors, it is possible to include a small local search around the vectors used in the co-location validation. Thus, f(V_{PN}) and f(V_{NP}) would involve a small search centred around the test vector, with the output being the minimum error found within that search area.

This disclosure is of use whenever a virtual frame motion estimator is used to find motion information at temporal locations where picture data is missing. The missing data is then optimally constructed using motion compensation of the temporally neighbouring and existing frames. For example, in a frame rate converter complete frames need to be computed in this manner as the output frames will not be temporally aligned with the source frames. Another application is restoration of partially damaged frames, where the damaged parts need to be constructed using the neighbouring frames—in this case the virtual frame actually coincides with an existing frame, but the parts where the picture data is missing/destroyed could be considered “virtual”, hence requiring this type of motion estimator.

What is claimed as new and desired to be protected by Letters Patent of the United States is:

1. A method for motion validation in a virtual frame motion estimator comprising selecting motion vectors for a virtual frame C, located at a temporal position between a previous frame P and a subsequent frame N, comprising computation of an extended error function based on the error for a vector V passing from frame P, through a reference block in the virtual frame C, to frame N, and using additional validation measures computed from vectors −V and +V starting from co-located blocks in P and N respectively, thereby reducing the risk for selecting erroneous vectors for said reference blocks in the virtual frame C.

2. A method in accordance with claim 1, comprising using said extended error function for each candidate vector passing through said reference block in virtual frame C and selecting the candidate with the minimum error.

3. A method in accordance with claim 2, comprising selecting a vector according to
min[a*f(V)+b*g(f(V_{PN}), f(V_{NP}))]_{Vε{Candidate vectors}}
where;
f(V) is an error value for a vector V passing from frame P, through a reference block in the virtual frame C, to frame N f(V_{PN}) is an error value for the co-located block in P using the motion vector −V referencing N;
f(V_{NP}) is an error value for the co-located block in N using the motion vector +V referencing P;
g(f(V_{PN}), f(V_{NP})) is a function that combines the results of the two error values f(V_{PN}) and
f(V_{NP}) for the co-located blocks; and
a and b are weighting factors.

4. A method in accordance with claim 3, where said error function f is calculated by summing absolute differences raised to a power x over pixels in areas referenced according to the vector V, where x is a positive number and the absolute difference is calculated for corresponding pixels in frame P and N.

5. A method in accordance with claim 4, where said power x is 1, which corresponds to the function f being the sum of absolute differences.

6. A method in accordance with claim 4, where said power x is 2, which corresponds to the function f being the sum of squared differences.

7. A method in accordance with claim 3, where said function g returns the sum of the minimum of the two operands multiplied with a factor d and the maximum of the two operands multiplied with a factor e.

8. A method in accordance with claim 7, where said factor d is 1 and said factor e is 0, which corresponds to the function g being the min function.

9. A method in accordance with claim 7, where said factor d is 0.5 and said factor e is 0.5, which corresponds to the function g being the average function.

10. A method for motion validation in a virtual frame motion estimator comprising selecting motion vectors for a virtual frame C, located at a temporal position between a previous frame P and a subsequent frame N, comprising computation of an extended error function based on the error for a vector V passing from frame P, through a reference block in the virtual frame C, to frame N, and using additional validation measures computed from vectors −V and +V starting from co-located blocks in P and N respectively, and using further additional validation measures computed using vector analysis from previously computed virtual frames and intermediate level results in a hierarchical motion estimator in order to create an error term related to previous occurrences of a specific candidate vector, thereby reducing the risk for selecting erroneous vectors for said reference blocks in the virtual frame C.

11. A method in accordance with claim 10, comprising using said extended error function for each candidate vector passing through said reference block in virtual frame C and selecting the candidate with the minimum error.

12. A method according to claim 11, comprising selecting a vector according to
min[a*f(V)+b*g(f(V_{PN}), f(V_{NP}))+c*h(V)]_{Vε{Candidate vectors}}
where;
f(V) is an error value for a vector V passing from frame P, through a reference block in the virtual frame C, to frame N
f(V_{PN}) is an error value for the co-located block in P using the motion vector −V referencing N;
f(V_{NP}) is an error value for the co-located block in N using the motion vector +V referencing P;
g(f(V_{PN}), f(V_{NP})) is a function that combines the results of the two error values f (V_{PN}) and
f(V_{NP}) for the co-located blocks;
h(V) is the error value related to previous occurrences of a specific candidate vector; and
a, b and c are weighting factors.

13. A method in accordance with claim 12, where said error function f is calculated by summing absolute differences raised to a power x over all pixels in areas referenced according to the vector V, where x is a positive number and the absolute difference is calculated for corresponding pixels in frame P and N.

14. A method in accordance with claim 13, where said power x is 1, which corresponds to the function f being the sum of absolute differences.

15. A method in accordance with claim 13, where said power x is 2, which corresponds to the function f being the sum of squared differences.

16. A method in accordance with claim 12, where said function g returns the sum of the minimum of the two operands multiplied with a factor d and the maximum of the two operands multiplied with a factor e.

17. A method in accordance with claim 16, where said factor d is 1 and said factor e is 0, which corresponds to the function g being the min function.

18. A method in accordance with claim 16, where said factor d is 0.5 and said factor e is 0.5, which corresponds to the function g being the average function.

19. A method in accordance with claim 12, where said function h is calculated by summing absolute vector differences raised to a power x, where x is a positive number and the vector differences are computed as an Euclidean distance or a block distance between the vector V and a set of vectors selected from a motion compensated (according to V) or co-located local neighbourhood in a previously computed virtual frame C, or a co-located local neighbourhood in a previous intermediate level in a hierarchical motion estimator, or both.

20. A method in accordance with claim 19, where said power x is 1, which corresponds to the function h being the sum of absolute differences.

21. A method in accordance with claim 19, where said power x is 2, which corresponds to the function h being the sum of squared differences.

22. A method in accordance with claim 19, where the set of vectors is chosen as all vectors within a specified region which is either co-located or motion compensated.

23. A method in accordance with claim 22, where the set of vectors is chosen as a number of those vectors which correspond to the smallest vector differences.

24. A method for motion validation in a virtual frame motion estimator comprising selecting motion vectors for a virtual frame C, located at a temporal position between a previous frame P and a subsequent frame N, comprising computation of an extended error function based on the error for a vector V passing from frame P, through a reference block in the virtual frame C, to frame N, and using additional validation measures computed from vectors −V′ and V″ starting from co-located blocks in P and N respectively, where −V′ and V″ are found by individually searching a small local area around the vector −V and +V respectively and selecting the vector which minimizes the error function, and using further additional validation measures computed using vector analysis from previously computed virtual frames and intermediate level results in a hierarchical motion estimator in order to create an error term related to previous occurrences of a specific candidate vector, thereby reducing the risk for selecting erroneous vectors for said reference blocks in the virtual frame C.

25. A method in accordance with claim 24, comprising using said extended error function for each candidate vector passing through said reference block in virtual frame C and selecting the candidate with the minimum error.

26. A method according to claim 25, comprising selecting a vector according to
min[a*f(V)+b*g(f(V_{PN}), f(V_{NP}))+c*h(V)]_{Vε{Candidate vectors}}
where;
f(V) is an error value for a vector V passing from frame P, through a reference block in the virtual frame C, to frame N
f(V_{PN}) is an error value for the co-located block in P using the motion vector −V′ referencing N, where −V′ is found by searching a small local area around the vector −V and selecting that vector which minimizes the error function f;
f(V_{NP}) is an error value for the co-located block in N using the motion vector V″ referencing P, where V′ is found by searching a small local area around the vector V and selecting that vector which minimizes the error function f;
g(f(V_{PN}), f(V_{NP})) is a function that combines the results of the two error values f(V_{PN}) and f(V_{NP}) for the co-located blocks;
h(V) is the error value related to previous occurrences of a specific candidate vector; and
a, b and c are weighting factors.

27. A method in accordance with claim 26, where said error function f is calculated by summing absolute differences raised to a power x over pixels in areas referenced according to the vector V, where the absolute difference is calculated for corresponding pixels in frame P and N.

28. A method in accordance with claim 27, where said power x is 1, which corresponds to the function f being the sum of absolute differences.

29. A method in accordance with claim 27, where said power x is 2, which corresponds to the function f being the sum of squared differences.

30. A method in accordance with claim 26, where said function g returns the sum of the minimum of the two operands multiplied with a factor d and the maximum of the two operands multiplied with a factor e.

31. A method in accordance with claim 30, where said factor d is 1 and said factor e is 0, which corresponds to the function g being the min function.

32. A method in accordance with claim 30, where said factor d is 0.5 and said factor e is 0.5, which corresponds to the function g being the average function.

33. A method in accordance with claim 26, where said function h is calculated by summing absolute vector differences raised to a power x, where x is a positive number and the vector differences are computed as the Euclidean distance or the block distance between the vector V and a set of vectors selected from a motion compensated (according to V) or co-located local neighbourhood in a previously computed virtual frame C, or a co-located local neighbourhood in a previous intermediate level in a hierarchical motion estimator, or both.

34. A method in accordance with claim 33, where said power x is 1, which corresponds to the function h being the sum of absolute differences.

35. A method in accordance with claim 33, where said power x is 2, which corresponds to the function h being the sum of squared differences.

36. A method in accordance with claim 33, where the set of vectors is chosen as all vectors within a specified region.

37. A method in accordance with claim 36, where the set of vectors is chosen as a number of those vectors which correspond to the smallest vector differences.
